(19) United States
(12) Patent Application Publication
(10) Pub. No.: US 2004/0246386 A1
(43) Pub. Date: Dec. 9, 2004

(54) Screen protection kit having a sizing grid

(76) Inventors: Judith M. Thomas, Southlake, TX (US); Robert A. Dean, Southlake, TX (US)

Correspondence Address: BROOKS KUSHMAN P.C., 1000 TOWN CENTER, TWENTY-SECOND FLOOR, SOUTHFIELD, MI, 48075, US

(21) Appl. No.: 10/454,030

(22) Filed: Jun. 4, 2003

(51) Int. Cl. H04N 5/65

(52) U.S. Cl. 348/818

(57) ABSTRACT

A screen protection shield assembly for protecting an information display screen is provided. The screen protection shield assembly is generally comprised of a transparent overlay sheet having a first and second side, a removable backing sheet, and an adhesive layer. The adhesive layer is applied to the first side of the transparent overlay sheet. The removable backing sheet is secured to the first side of the transparent overlay sheet by the adhesive layer. The removable backing sheet includes a sizing grid for sizing the transparent overlay sheet to an information display screen to obtain an application size. The transparent overlay sheet and the removable backing sheet are trimmed to about the application size, and the trimmed transparent overlay sheet is removed from the trimmed removable backing sheet. The trimmed transparent overlay sheet is then secured to the information display screen by the adhesive layer.

### BACKGROUND OF THE INVENTION

1. Field of the Invention

One aspect of this invention relates to an apparatus and method for protecting an information display screen from scratches and damaging contaminants, such as oils, dirt, and grime.

2. Background Art

An information display screen can be any screen that displays graphic images or text for viewing by a user. The graphic images and text can be generated by an electronic device associated with a particular information display screen. These electronic devices and information display screens are available in a variety of shapes and sizes depending upon the electronic device's particular function. Regardless of an electronic device's function, information display screens are susceptible to damage and degradation caused by excessive exposure to the environment. When substances such as dirt, grime, or oils come in contact with an information display screen, the performance of the information display screen can be significantly reduced over time. Further, an exposed information display screen is susceptible to nicks and scratches from harder materials contacting it. As a result, excessive exposure to the environment can mar the surface of an information display screen prohibiting optimal performance and viewability.

Impaired information display screens are a common and costly problem for individuals owning electronic devices. Since electronic devices can be quite expensive, replacement is seldom an option. Consequently, many individuals are forced to either repair or replace the information display screen. Unfortunately, this alternative is fairly costly and inconvenient as well.

Various systems have been proposed to protect an information display screen from exposure to the environment, thereby extending its performance. Among the most common is pre-cut transparent overlays customized for the specific information display screen. Such overlays provide a barrier between the environment and the information display screen, preventing contact with damaging substances or materials. However, the aforementioned overlays typically fit only specific electronic devices, resulting in an almost indefinite number of such customized overlays. For individuals desiring to protect the information display screens of multiple different electronic devices, purchase of a different customized overlay for each electronic device is often required.

More and more individuals and companies have multiple electronic devices with information display screens in need of protection. In the past, an individual would be required to purchase separate pre-customized screen protectors for each electronic device. In some instances, a customized screen protector for an information display screen of a particular electronic device may not be available. Over time, this can prove to be quite costly for an individual or business with multiple information display screens to protect. One alternative is to choose not to protect their information display screens at all. This can be a costly alternative as well because it introduces the likelihood of reducing the life of the electronic devices.

Alternatively, other methods that allow for the customization of an overlay, such as transparent contact paper, are not intended or designed for protecting an information display screen. These methods can provide a reference guide in the form of a grid for outlining a particular information display screen, in order to trim the paper to a proper size. However, such methods can inhibit ordinary function of an information display screen and further, hinder its viewability because of poor optical qualities. Moreover, such methods fail to provide an adequate barrier from environmental elements.

### SUMMARY OF THE INVENTION

One aspect of the present invention is to provide a shield and method for information display screen protection, including preventing excessive exposure and contact with extraneous materials and objects.

Another aspect of the present invention is to provide a shield and method for information display screen protection that does not inhibit ordinary function of the information display screen.

Yet another aspect of the present invention is to provide a shield and method for information display screen protection that enhances information display screen function and minimizes glare.

Still yet another aspect of the present invention is to provide a shield and method for information display screen protection wherein the shield is of a generic size and can be customized by use of a sizing grid to fit a particular information display screen.

Still yet another aspect of the present invention is to provide a kit for conveniently retaining a supply of shields and additional accessories useful for information display screen protection.

Accordingly, a shield assembly for protecting an information display screen is provided. The shield includes a transparent overlay sheet, a transparent removable backing sheet, and a layer of adhesive material disposed therebetween. A sizing grid can be printed upon the removable backing sheet for sizing the transparent overlay sheet according to an information display screen size. In operation, the transparent overlay sheet and the removable backing sheet can be trimmed to a particular information display screen. The trimmed transparent overlay sheet can then be removed from the removable backing sheet and applied to the particular information display screen. The adhesive layer secures the trimmed transparent overlay sheet to the particular information display screen forming a barrier between the information display screen and external elements.

In a certain embodiment, the transparent overlay sheets are generally thin, rectangular sheets, and are formed from a transparent plastic material. In addition, a corner section of the removable backing sheet can be scored to assist in separating the two sheets. The removable backing sheet further includes an area for printing application instructions thereon. The instructions can be referenced by a user for guidance during the application process. Furthermore, a positioning arrow can be provided with the sizing grid to aid the user in aligning the sizing grid over the information display screen when sizing the transparent overlay sheet.

Correspondingly, a method for protecting an information display screen is provided. The method includes providing a screen protection shield assembly having a transparent overlay sheet for attachment to an information display screen. A transparent removable backing sheet, which includes a sizing grid, can be attached to the transparent overlay sheet by an adhesive layer. The method also includes sizing the transparent overlay sheet to fit a particular information display screen by marking the sizing grid. The method further includes trimming the screen protection shield assembly based on the marked sizing grid to obtain a trimmed transparent overlay sheet that fits the information display screen. Still further, the method includes applying the trimmed transparent overlay sheet to the information display screen by removing the removable backing sheet from the trimmed overlay sheet.

In further accordance with a certain embodiment of the present invention, a screen protection kit is provided. The screen protection kit can include a plurality of screen protection shield assemblies, an applicator card, a cleaning cloth, an instruction manual, and a storage receptacle. The applicator card can be generally used for removing air bubbles between the information display screen and the transparent overlay sheet upon application. The cleaning cloth can be used to remove debris from the surface of the information display screen. The instruction manual can be referenced to describe how to apply the transparent overlay sheets. The plurality of screen protection shield assemblies can be packaged together, along with the applicator card, cleaning cloth, and manual, in the storage receptacle for later use.

The above aspects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a plan view of a screen protection shield assembly showing the various layers of the shield assembly;

FIG. 2 is an enlarged side sectional view of the screen protection shield assembly of FIG. 1;

FIG. 3a depicts a method for cleaning an information display screen with a cleaning cloth;

FIG. 3b depicts a method for superimposing a screen protection shield assembly with an information display screen;

FIG. 3c depicts a method for marking a sizing grid of a screen protection shield assembly according to the size of an information display screen;

FIG. 3d depicts a method for trimming a screen protection shield assembly according to markings on a sizing grid;

FIG. 3e depicts a method for peeling a transparent overlay sheet away from a removable backing sheet;

FIG. 3f depicts a method for aligning and applying a transparent overlay sheet to an information display screen;

FIG. 3g depicts a method for aiding in the application of a transparent overlay sheet by sliding an applicator card across the surface of an information display screen;

FIG. 4a is an exploded view of a screen protection kit showing a plurality of screen protection shield assemblies, a cleaning cloth, an applicator guard, and a shield assembly receptacle;

FIG. 4b is a perspective view of the screen protection kit of FIG. 4a showing the plurality of screen protection shield assemblies, the cleaning cloth, and the applicator card packaged together in the shield assembly receptacle;

FIGS. 5a is an exploded perspective view of an alternative screen protection kit showing a plastic receptacle which can contain a plurality of screen protection shield assemblies, a cleaning cloth, an applicator card, and an instruction manual; and

FIGS. 5b is a perspective view of the alternative screen protection kit of FIGS. 5a showing a plastic receptacle which is closed to secure contents within.

### DETAILED DESCRIPTION OF THE PREFERRED EMBODIMENT(S)

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

One aspect of the present invention is directed to an apparatus and method for protecting an information display screen from exposure to damaging materials and substances. As described in greater detail below, the apparatus, according to the present invention, functions as a shield to prevent damaging materials from contacting the information display screen by providing a protective barrier between the screen and the environment. The ability of the apparatus of the present invention to shield against direct contact and environmental exposure reduces the likelihood of information display screen degradation, thereby extending the life of the product.

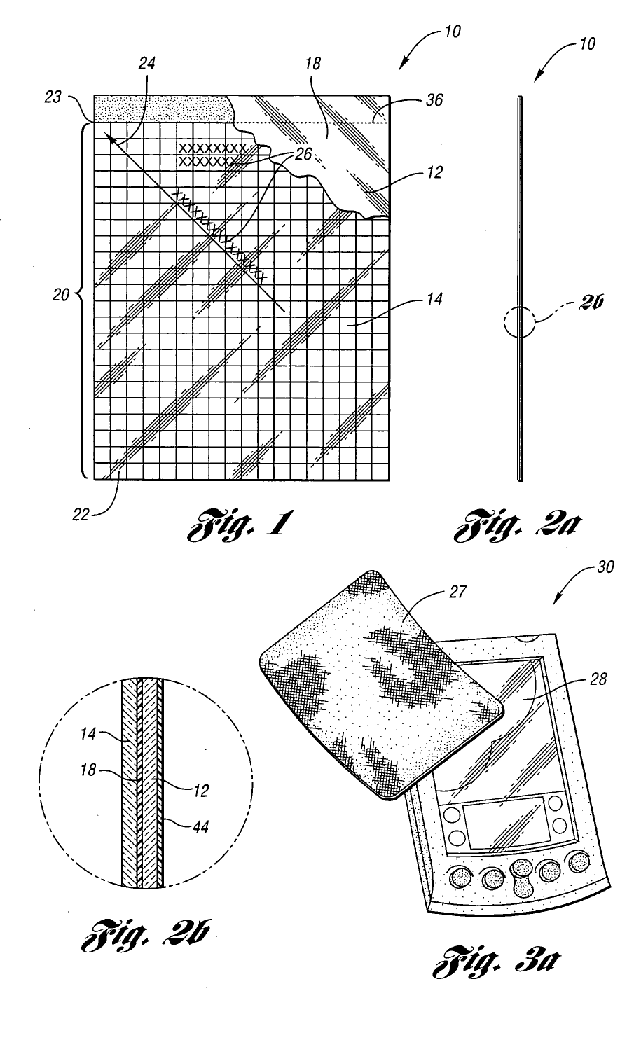

Referring to FIG. 1, a screen protection shield assembly 10 in accordance with a certain embodiment of the present invention is illustrated. Screen protection shield assembly 10 is comprised of transparent overlay sheet 12 and transparent removable backing sheet 14. Sheets 12 and 14 are generally rectangular and are of the same general size, shape and orientation. In this embodiment, shield assembly 10 can be about 3.0 inches wide by about 3.75 inches long. However, it is fully contemplated that any combination of widths and lengths can be provided without limiting the scope of this invention. Preferably, transparent overlay sheet 12 and removable backing sheet 14 are thin sheets constructed from a flexible plastic material such as vinyl, polyester, or the like. In this embodiment, transparent overlay sheet 12 and removable backing sheet 14 are attached to one another, as shown in FIG. 1. Transparent adhesive layer 18, best shown in FIG. 2, is disposed between transparent overlay sheet 12 and removable backing sheet 14 to secure transparent overly sheet 12 to removable backing sheet 14. Adhesive layer 18 may be a low-tack adhesive such as a solvent acrylic, or the like, such that removable backing sheet 14 can be removed from transparent overlay sheet 12 with relatively little difficulty. Removable backing sheet 14 is not limited to one single sheet. Rather, it is fully contemplated that removable backing sheet 14 can be comprised of multiple sheets to facilitate easier removal from transparent overlay sheet 12, similar to that of a name tag. Preferably, adhesive layer 18 is primarily adhered to transparent overlay sheet 12 such that transparent overlay sheet 12 retains its adhesive properties upon removal of removable backing sheet 14.

Referring again to FIG. 1, removable backing sheet 14 may contain sizing grid 20 printed thereon. Sizing grid 20 comprises a plurality of small squares 22 which are generally equally sized and arranged to form a grid. Sizing grid 20 has origin 23 in close proximity with a corner of the removable backing sheet 14. In certain embodiments, each square 22 has a side length about 0.125 inches. However, squares 22 may be sized at any desirable length, in accordance with the teachings of this invention. Further, sizing grid 20 may encompass at least about 60% of the surface area of removable backing sheet 14, and in certain embodiments at least about 90%. Of course, it is fully contemplated that sizing grid 20 can occupy a larger or smaller area.

The advantage of sizing grid 20 is that it provides a reference guide for sizing shield assembly 10 to a size approximate information display screens of varying size. Shield assembly 10 provides an easy and cost effective method for extending the life of an individual or business'electronic devices having information display screens. Shield assembly 10 is generic in size and is typically larger than most information display screens. This allows for shield assembly 10 to be customized to the approximate size of any number of particular information display screens. Sizing grid 20 provides a convenient reference guide for sizing and marking shield assembly 10 to a size approximate a particular information display screen. Once shield assembly 10 is appropriately sized and marked, it can be trimmed for later application to that particular information display screen. Therefore, the need to purchase separate pre-customized screen protectors for each electronic device having an information display screen is eliminated.

In a certain embodiment, positioning arrow 24 is printed atop sizing grid 20. As shown in FIG. 1, positioning arrow 24 is generally oriented to indicate origin 23 of sizing grid 20.

In another certain embodiment, removable backing sheet 14 contains instructions 26 for applying transparent overlay sheet 12 to an information display screen. Application instructions 26 can describe in concise terms a method for applying shield assembly 10, in accordance with the teachings of the present invention, which will be described in further detail below. Application instructions 26 can be printed in a region void of sizing grid 20 so that sizing grid 20 does not impair a user's ability to read the application instructions. However, it is fully contemplated that the all or part of application instructions 26 can be printed directly over top sizing grid 20.

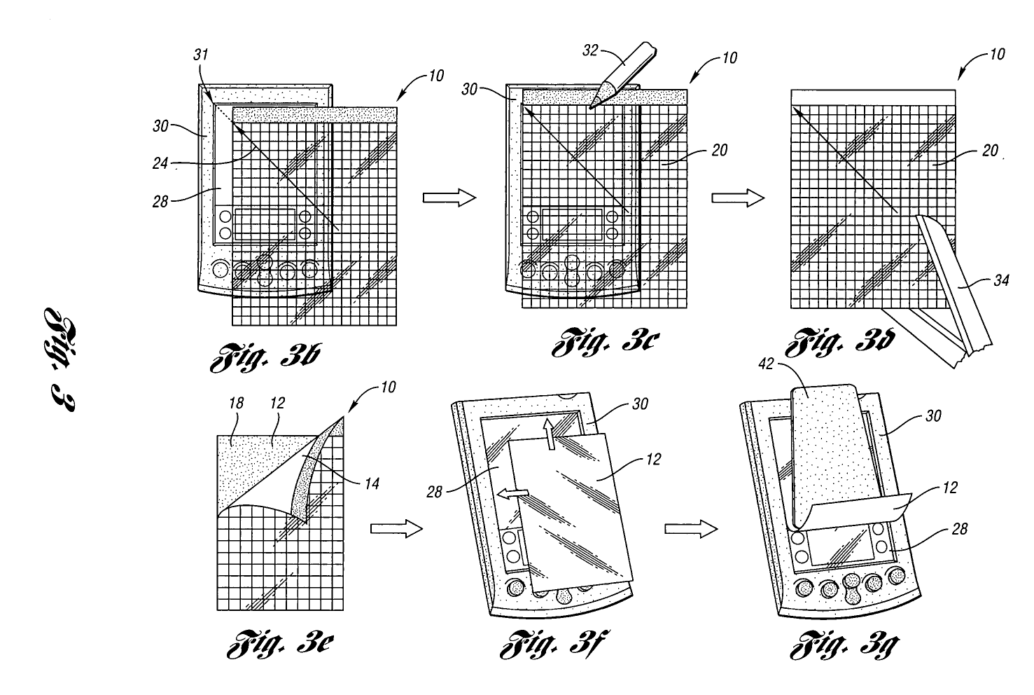

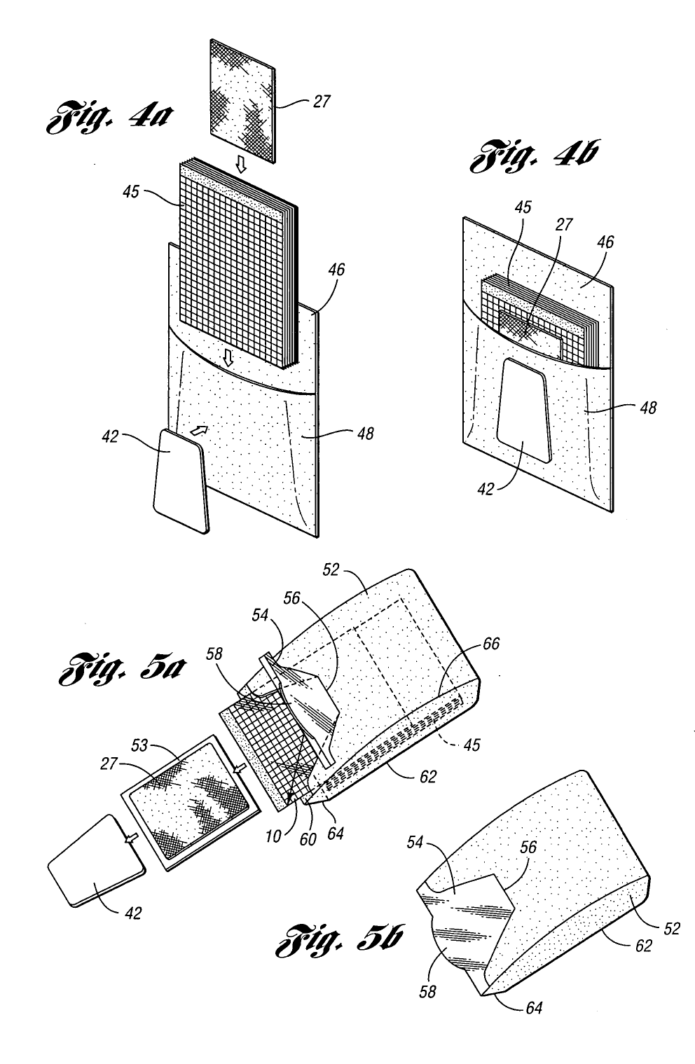

Referring now to FIGS. 3a-3g, a certain method for applying transparent overlay sheet 12 is described in detail. First, cleaning cloth 27 is applied to information display screen 28 of personal digital assistant (PDA) 30, as shown in FIG. 3a, to thoroughly clean information display screen 28 from debris prior to applying transparent overlay sheet 12. Cleaning information display screen 28 creates a better surface for adhesive layer 18 to adhere to, and also reduces the likelihood of debris to be trapped between information display screen 28 and transparent overlay sheet 12, thereby improving viewability. Cleaning cloth 27 may be comprised of a micro fiber cloth material attached to a portion of flexible plastic. As will be described in detail later in this application, cleaning cloth 27 may be provided with screen protection shield assembly 10 to aid in cleaning information display screen 28. It is, of course, fully contemplated that alternative methods or materials for cleaning information display screen 28 are available, in accordance with the teachings of the present invention.

Referring now to FIG. 3b, shield assembly 10 is superimposed above information display screen 28 of PDA 30. Shield assembly 10 can be oriented such that the tip of positioning arrow 24 is located in corresponding corner 31 of information display screen 28. In this arrangement sizing grid 20 is designed to cover at minimum all of information display screen 28.

With reference now to FIG. 3c, marking instrument 32 is utilized to mark sizing grid 20 with trim lines representing the approximate size of information display screen 28, thereby indicating a region to be trimmed. Although marking instrument 32 can be any instrument capable of manufacturing a viewable mark on sizing grid 20, in a certain embodiment, marking instrument 32 is a pen or pencil, or the like. Upon marking sizing grid 20 with marking instrument 32, shield assembly 10 is removed from atop PDA 30.

Referring now to FIG. 3d, shield assembly 10 is trimmed along the previously marked trim lines, using sizing grid 20 and the marked trim lines as a reference. Sizing grid 20, in combination with the marked trim lines, provide a guide for adequately trimming shield assembly 10 to a size approximate information display screen 28. As shown in FIG. 3d, shield assembly 10 can be trimmed by pair of scissors 34. However, it is fully contemplated that shield assembly 10 can be trimmed by alternative instruments, such as a knife blade, razor, or the like.

With reference to FIG. 3e, shield assembly 10 is now of a size approximate information display screen 28. Accordingly, transparent overlay sheet 12 and removable backing sheet 14 are also of a size approximate the information display screen 28. A portion of transparent overlay sheet 12 can be peeled from removable backing sheet 14 exposing a portion of the adhesive layer 18 of transparent overlay sheet 12, as shown in FIG. 3e. In a certain embodiment, transparent overlay sheet 12 includes scored edge 36, as shown in FIG. 1. Scored edge 36 can be located near the top of shield assembly 10 and can extend horizontally across the entire width of transparent overlay sheet 12 intersecting origin 23. Scored edge 36 alleviates the difficulty in separating transparent overlay sheet 12 from removable backing sheet 14. Normally, a user would have the cumbersome task of separating transparent overlay sheet 12 and removable backing sheet 14 at the outermost edge of shield assembly 10. By use of scored edge 36, a user simply folds removable backing sheet 14 away from transparent overlay sheet 12 exposing scored edge 36. The user then grabs transparent overlay sheet 12 at scored edge 36 and peels the desired amount away from removable backing sheet 14.

Referring now to FIG. 3f, the exposed portion of transparent overlay sheet 12 is aligned such that its edges correspond to edges of the information display screen 28. The adhesive layer 18 secures the exposed portion of transparent overlay sheet 12 to information display screen 28. Should a user misalign transparent overlay sheet 12 with information display screen 28, the adhesive layer 18 allows transparent overlay sheet 12 to be gently lifted, repositioned, and reapplied properly.

As shown in FIG. 3g, applicator card 42 can be used to apply the transparent overlay sheet 12 securely to the information display screen 28 by sliding applicator card 42 across the surface of information display screen 28 as removable backing sheet 14 is peeled away from transparent overlay sheet 12. Further, any air bubbles resultant from the application of transparent overlay sheet 12 to information display screen 28 can be removed by sliding applicator card 42 across the surface of information display screen 28. Applicator card 42 may be formed from a rigid plastic material and is generally trapezoidal in shape. Additionally, applicator card 42 may include supplemental application instructions printed thereon.

Once transparent overlay sheet 12 is applied to an information display screen 28, the transparent overlay sheet 12 provides an additional layer of protection to information display screen 28. Absent transparent overlay sheet 12, an information display screen 28 is susceptible to damage, such as scratches and cracks. When in place, transparent overlay sheet 12 works to resist such scratches and cracks. Moreover, transparent overlay sheet 12 maintains information display screen 28 free from substances, such as dirt or grime, or the like. Such substances, over time, affect the overall performance of the information display screen 28, thereby reducing the life of PDA 30. By protecting the information display screen 28 from such substances, the performance of the information display screen 28 can be extended.

Although it is important to protect information display screen 28 from damage and degradation, it is also important to protect information display screen 28 without inhibiting its ordinary function. Therefore, another aspect of the present invention includes a screen protection shield assembly that does not hinder or impair normal screen function. As previously mentioned, transparent overlay sheet 12 is generally completely transparent, not merely semi-transparent, to present an image from information display screen 28 comparable to that of an exposed information display screen. Moreover, information display screen 28 may be a touch screen, such as in PDA 30. Transparent overlay sheet 12 is designed to allow information to be entered into such a touch screen without difficulty. In certain embodiments, transparent overlay sheet 12 increases a user's ability to enter information into an electronic device such as PDA 30 via information display screen 28.

Referring back to FIGS. 3a-3g, PDA 30 is just one example of many electronic devices having information display screens in need of protection. Additional electronic devices can include, but are not limited to, camcorders, digital cameras, cellular phones, portable phones, touchscreen remote controls, portable DVD players, in-dash car stereo receivers, and vehicle navigational systems. Further, additional electronic devices may have information display screens of varying size and shape. However, like electronic devices typically have similar sized information display screens. For example, information display screens associated with portable DVD players are typically greater in size than information display screens associated with cellular phones. Therefore, it may be desirable to provide screen protection shield assemblies sized to cooperate with a particular genus of electronic devices. For example, screen protection shield assembly 10 may be sized generally to cooperate with portable DVD players. Alternative screen protection shield assemblies may be sized generally to cooperate with cellular phones or PDAs or the like. Of course, it is fully contemplated that like electronic devices have information display screens of varying size and shape within a particular genus.

Referring back to FIG. 2, in a certain embodiment, transparent overlay sheet 12 is provided with anti-reflective coating 44 to minimize glare from ambient light sources, such as sunlight and overhead lighting. Ambient light can shine on information display screen 28 creating annoying reflections and reducing the contrast of images displayed on information display screen 28. Contrast can be defined as how bright the information display screen images appear against the background. Greater contrast results in increased viewability of information displayed on an information display screen. Anti-reflective coating 44 can act as a filter to disburse reflected ambient light, diverting it from the viewing area of information display screen 28. Anti-reflective coating 44 can accomplish this without diffusing or softening the images displayed on information display screen 28.

In yet another certain embodiment, a plurality of screen protection shield assemblies 45 are packaged together in a stack arrangement. Referring to FIGS. 4a and 4b, the plurality of shield assemblies 45 can be accompanied by cleaning cloth 27, applicator card 42 and shield assembly receptacle 46 having pocket 48. The plurality of shield assemblies 45 can be inserted into pocket 48 for storage. Over time, the need to replace screen protection shield assembly 10 on information display screen 28 may arise. In this embodiment, a user may discard an old shield and choose a new shield from the plurality of screen protection shield assemblies 45 located in shield assembly receptacle 46. Shield assembly receptacle 46 may store up to an amount of shields sufficient to protect information display screen 28 for one year. However, it is fully contemplated that shield assembly receptacle 46 can be designed to store plurality of shield assemblies 45 in an amount greater than a one year supply. Cleaning cloth 27 can also be stored in pocket 48 of shield assembly receptacle 46 for convenient access during transparent overlay sheet replacement or other activity relating to electronic device care. Further, shield assembly receptacle 46 provides a region for storing applicator card 42. As shown in FIGS. 4a and 4b, applicator card 42 can be attached to the outside surface of pocket 48 with the aid of an adhesive substance adhered to the outside surface of pocket 48. It is fully contemplated that this is just one method by which applicator card 42 can be stored alongside shield assembly receptacle 46, and that additional methods exist.

With reference to FIGS. 5a and 5b, still yet another certain embodiment is provided, in accordance with the teachings of the present invention. In this embodiment, plastic receptacle 52 is provided having a generally boxed enclosure for encapsulating a plurality of screen protection shield assemblies 45, cleaning cloth 27, applicator card 42, and instruction manual 53. Instruction manual 53 comprises a foldable portion of paper having a step-by-step instruction set printed thereon for applying shield assembly 10. Plastic receptacle 52 includes locking lid 54 having hinge 56 and flange 58. Locking lid 54 communicates with plastic receptacle 52 to define opening 60 in plastic receptacle 52. Opening 60 provides access to plurality of screen protection shield assemblies 45 when locking lid 54 is opened. Opening locking lid 54 is easily accomplished by use of flange 58, which provides an edge for lifting locking lid 54. With locking lid 54 in the upright and open position, as shown in FIG. 5a, a user can easily retrieve a screen protection shield assembly 10 from plurality of screen protection shield assemblies 45. Plastic receptacle 52 provides bottom surface 62 upon which plurality of screen protection shield assemblies 45 rest. Bottom surface 62 includes tapered section 64, which leads into opening 60. Tapered section 64 allows a user to reach into plastic receptacle 52 through opening 60 and slide out screen protection shield assembly 10. When not in use, opening 60 and plastic receptacle 52 can be closed by flipping down locking lid 54 until it snaps together with plastic receptacle 52. With plastic receptacle 52 in the closed configuration as shown in FIG. 5b, plurality of screen protection shield assemblies 45, cleaning cloth 27, applicator card 42, and manual 53 can be conveniently stored for later use.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A screen protection shield assembly for protecting an information display screen comprising:
a transparent overlay sheet having a first and second side;
an adhesive layer applied to the first side of the transparent overlay sheet; and
a transparent removable backing sheet, having a size similar to the transparent overlay sheet, secured to the first side of the transparent overlay sheet by the adhesive layer, and having a grid for enabling a user to size the transparent overlay sheet according to an information display screen to obtain an application size,
wherein the transparent overlay sheet and the removable backing sheet is trimmed to about the application size, the trimmed removable backing sheet is removed from the trimmed transparent overlay sheet, and the trimmed transparent overlay sheet is secured to the information display screen by the adhesive layer.

2. The screen protection shield assembly of claim 1, wherein the transparent overlay sheet and the removable backing sheet are generally rectangular.

3. The screen protection shield assembly of claim 1, wherein an area adjacent to a corner of the removable backing sheet is scored to aid in removing the removable backing sheet from the transparent overlay sheet.

4. The screen protection shield assembly of claim 1, wherein the transparent overlay sheet is comprised of a vinyl material.

5. The screen protection shield assembly of claim 1, wherein the adhesive layer is a solvent acrylic.

6. The screen protection shield assembly of claim 1, wherein the removable backing sheet is comprised of a transparent polyester material.

7. The screen protection shield assembly of claim 1, wherein the removable backing sheet includes sizing instructions.

8. The screen protection shield assembly of claim 1, wherein an anti-reflective coating is applied to at least one surface of the transparent overlay sheet.

9. The screen protection shield assembly of claim 1, wherein the sizing grid includes a positioning arrow.

10. The screen protection shield assembly of claim 1, wherein the removable backing sheet is markable with a pen or pencil so that a user can superimpose the assembly with an information display screen and mark the removable backing sheet according to the information display screen.

11. A method for applying a screen protection shield assembly to an information display screen comprising:
providing a screen protection shield assembly having a transparent overlay sheet for attachment to an information display screen, the transparent overlay sheet having a removable backing sheet attached thereto by an adhesive layer, and the removable backing sheet having a sizing grid;
superimposing the shield assembly with the information display screen to be protected, facing removable backing sheet of the shield assembly upward;
marking the sizing grid of the removable backing sheet corresponding to a size approximate the information display screen;
trimming the assembly according to the marked grid so that the transparent overlay sheet fits the information display screen;
removing the transparent overlay sheet from the removable backing sheet; and
applying the transparent overlay sheet to the information display screen by placing the transparent overlay sheet on the information display screen.

12. The method of claim 11, wherein the transparent overlay sheet and the removable backing sheet are generally rectangular.

13. The method of claim 11, wherein an area adjacent to a corner of the removable backing sheet is scored to aid in removing the removable backing sheet from the transparent overlay sheet.

14. The method of claim 11, wherein the removable backing sheet includes application instructions.

15. The method of claim 11, further comprising cleaning debris from the information display screen with a cleaning cloth prior to applying the transparent overlay sheet.

16. The method of claim 11, further comprising using an applicator card to aid in applying the transparent overlay sheet securely to the information display screen by sliding the applicator card across the information display screen.

17. A screen protection kit for protecting an information display screen comprising:
a plurality of screen protection shield assemblies having a transparent overlay sheet; and
a receptacle for retaining the plurality of screen protection shield assemblies.

18. The screen protection kit of claim 17, wherein the receptacle is comprised of a flexible plastic material having a locking lid that opens to provide access to the contents of the receptacle and closes to secure the contents of the receptacle within.

19. The screen protection kit of claim 17, wherein each screen protection shield assembly is further comprised of an adhesive layer applied to one side of the transparent overlay sheet and a transparent removable backing sheet secured to the transparent overlay sheet by the adhesive layer.

20. The screen protection kit of claim 17, further comprising an applicator card for removing air bubbles between the information display screen and the transparent overlay sheet upon application.

21. The screen protection kit of claim 20, wherein the applicator card is comprised of a rigid plastic material and is generally trapezoidal in shape.

22. The screen protection kit of claim 17, further comprising a cleaning cloth for removing debris from the information display screen.

23. The screen protection kit of claim 22, wherein the cleaning cloth is comprised of a flexible plastic material affixed to a cloth material and is generally rectangular in shape.

24. The screen protection kit of claim 17, further comprising a manual with instructions on how to apply the transparent overlay sheet.

25. The screen protection kit of claim 17, wherein the manual containing application instructions is printed on paper and is generally rectangular in shape.
